(19) United States
(12) Patent Application Publication
(10) Pub. No.: US 2009/0141185 A1
(43) Pub. Date: Jun. 4, 2009

(54) BROADCAST RECEIVING APPARATUS AND METHOD FOR SWITCHING CHANNEL THEREOF

(75) Inventor: Do-sung Jung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/126,130

(22) Filed: May 23, 2008

(30) Foreign Application Priority Data
Dec. 3, 2007 (KR) 10-2007-0124477

(51) Int. Cl. H04N 5/44; G06F 13/00

(52) U.S. Cl. 348/734; 725/38; 340/825.72; 348/E05.096

(57) ABSTRACT

A broadcast receiving apparatus and a method for switching a channel thereof are disclosed, the broadcast receiving apparatus including a channel switch unit which monitors the condition of a channel used to communicate with a remote controller, and sets a new channel to be switched with a current channel if the channel condition is inappropriate for communication; and a transceiver which transmits a channel switch request message to request a channel be switched to the new channel set by the channel switch unit. Therefore, the broadcast receiving apparatus is easily switch a channel used to communicate with a remote controller irrespective of a sleep mode of the remote controller.

### CROSS-REFERENCE TO RELATED APPLICATIONS

This application claims priority under 35 U.S.C. § 119 from Korean Patent Application No. 10-2007-0124477, filed on Dec. 3, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to a channel switch, and more particularly, to a broadcast receiving apparatus for efficiently switching a channel without affecting data transmitting and receiving operations between the broadcast receiving apparatus and a remote controller, and a method for switching a channel thereof.

2. Description of the Related Art

Recently, broadcasting stations provide users with various services such as digital broadcasting. Digital broadcasting includes the process of digitizing a broadcast signal such as an audio signal, a video signal, or a data signal, processing the signal, and transmitting the signal to a transmission system or receiving the signal using a digital method. A user manipulates buttons provided in a broadcast receiving apparatus or a remote controller to replay or stop the digital broadcast.

With the development of a broadcast communication technique, data are transmitted and received between a broadcast receiving apparatus and a remote controller using a wireless personal area network (WPAN) in addition to infrared. The communication using the WPAN includes WiFi, Bluetooth, and ZigBee.

When data are transmitted and received between a broadcast receiving apparatus and a remote controller through the WPAN, and the remote controller is in a sleep mode, the remote controller cannot perceive if a channel is switched, so a channel to transmit and receive data is varied between the broadcast receiving apparatus and the remote controller, and the data cannot be transmitted and received. The sleep mode represents a state in which data is not transmitted and received, but power is supplied to essential components such as a central processing unit (CPU) of the remote controller.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a broadcast receiving apparatus which monitors a channel condition, and requests a channel switch for efficient data transmission and reception between the broadcast receiving apparatus and a remote controller, and a method for switching a channel thereof.

According to an exemplary aspect of the present invention, there is provided a broadcast receiving apparatus, comprising a channel switch unit which monitors the condition of a channel used to communicate with a remote controller, and sets a new channel according to energy of a monitored channel; and a transceiver which transmits a channel switch request message to request a channel be switched to the new channel set by the channel switch unit.

If the energy of a current channel used to communicate with the remote controller is less than a predetermined reference energy, the channel switch unit may compare the energy of the current channel with the energy of one of a plurality of channels, and set the new channel.

The channel switch unit may select a channel to be compared with the current channel from the plurality of channels according to a predetermined channel priority order, and set the selected channel to be the new channel if the energy of the selected channel is larger than the sum of the current channel energy and the predetermined reference energy.

If data are received from the remote controller, the transceiver may transmit an acknowledgement packet for the received data and the channel switch request message to the remote controller.

If data are received from the remote controller, the transceiver may determine that the remote controller wakes up from a sleep mode, and transmit the channel switch request message.

The transceiver may receive a channel switch allowance message as a receipt for the channel switch request message, and the channel switch unit may switch a channel to the new channel if the channel switch allowance message is received through the transceiver.

The transceiver may receive data from the remote controller over the new channel, and transmit an acknowledge packet for the received data and channel information regarding a channel used to communicate with the remote controller to the remote controller over the new channel.

The apparatus may further comprise a storage which stores channel information including a channel number of the new channel, wherein the channel switch request message includes the channel information of the new channel.

The transceiver may transmit the channel switch request message to the remote controller using a ZigBee communication protocol.

According to an exemplary aspect of the present invention, there is provided a method for switching a channel, comprising monitoring the condition of a channel used to communicate with a remote controller by a predetermined reference time, and setting a new channel according to energy of a monitored channel; and transmitting a channel switch request message to request a channel be switched to the set new channel.

If the energy of a current channel used to communicate with the remote controller is less than a predetermined reference energy, the setting may comprise comparing the energy of the current channel with the energy of one of a plurality of channels, and setting the new channel.

The setting may comprise selecting a channel to be compared with the current channel from the plurality of channels according to a predetermined channel priority order; and setting the selected channel to be the new channel if the energy of the selected channel is larger than the sum of the current channel energy and the predetermined reference energy.

If data are received from the remote controller, the transmitting may comprise transmitting an acknowledgement packet for the received data and the channel switch request message to the remote controller.

The transmitting may receive a channel switch allowance message as a receipt for the channel switch request message, and the setting may switch a channel to the new channel if the channel switch allowance message is received.

The transmitting may comprise receiving data from the remote controller over the new channel, and transmitting an acknowledge packet for the received data and channel information regarding a channel in which the acknowledge is transmitted over the new channel.

The method may further comprise storing channel information including a channel number of the new channel, wherein the channel switch request message includes the channel information of the new channel.

The transmitting may transmit the channel switch request message using a ZigBee communication protocol.

According to an exemplary aspect of the present invention, there is provided a remote controller, comprising a transceiver which receives a channel switch request message from an external apparatus, and transmits a channel switch allowance message as a receipt for the channel switch request message; and a channel switch unit which switches a current channel used to communicate to the external apparatus according to the channel switch request message received through the transceiver.

The channel switch request message may include channel information representing a channel number of a channel to be switched, and the channel switch unit may switch the current channel to the channel number included in the channel switch request message if a predetermined time is elapsed since the channel switch allowance message is transmitted through the transceiver.

The transceiver may transmit and receive data over the channel switched by the channel switch unit.

According to an exemplary aspect of the present invention, there is provided a method for switching a channel, comprising receiving a channel switch request message from an external apparatus, and transmitting a channel switch allowance message as a receipt for the channel switch request message; and switching the current channel used to communicate with the external apparatus according to the received channel switch request message.

The channel switch request message may include channel information representing a channel number of a channel to be switched, and the switching may switch the current channel to the channel number included in the channel switch request message if a predetermined time is elapsed since the channel switch allowance message is transmitted at the transmitting.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a broadcast receiving apparatus according to an exemplary embodiment of the present invention.

FIG. 2 is a block diagram illustrating the structure of a communication module according to an exemplary embodiment of the present invention.

FIG. 3 is a flowchart provided to explain the operation of a broadcast receiving apparatus according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since that would obscure the invention with unnecessary detail.

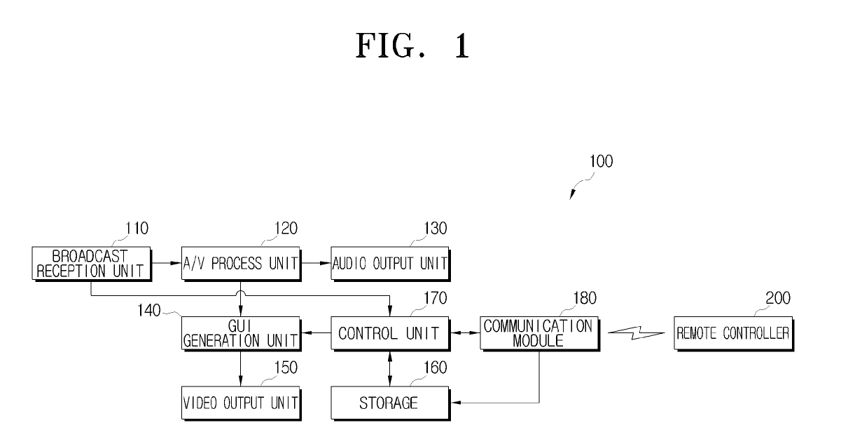

FIG. 1 is a block diagram illustrating a broadcast receiving apparatus according to an exemplary embodiment of the present invention.

Referring to FIG. 1, a broadcast receiving apparatus 100 may comprise a broadcast reception unit 110, an audio and video (A/V) process unit 120, an audio output unit 130, a graphical user interface (GUI) generation unit 140, a video output unit 150, a storage 160, a control unit 170, and a communication module 180.

The broadcast reception unit 110 receives broadcast or content from a broadcasting station or satellite over wire or wirelessly, and demodulates the received broadcast or content.

The A/V process unit 120 processes a broadcast signal output from the broadcast reception unit 110 in a manner of video decoding, video scaling, and audio decoding. The A/V process unit 120 transmits a video signal and audio signal to the GUI generation unit 140 and audio output unit 130, respectively.

The audio output unit 130 outputs an audio signal output from the A/V process unit 120 through a speaker or an external apparatus connected to an external output terminal.

The GUI generation unit 140 generates a GUI to be displayed on a display, that is, to be displayed on the video output unit 150, and combines the generated GUI with a video output from the A/V process unit 120.

The video output unit 150 displays on a display a video combining a GUI output from the GUI generation unit 140, or outputs the video to an external apparatus connected to an external output terminal (not shown).

The storage 160 stores various programs to control overall operations of the broadcast receiving apparatus 100, content received from the broadcast receiving apparatus 100, and channel information received from the communication module 180. The content includes a still image, moving image, and music file, and the channel information includes a channel number.

The control unit 170 stores broadcast program and content received from the broadcast reception unit 110 in the storage 160, and controls the communication module 180 to store in the storage 160 the channel information regarding the channel set by the communication module 180.

The communication module 180 receives data from a remote controller 200, and monitors the condition of a channel, which is used to communicate with the remote controller 200, in a manner of scanning a channel by a predetermined reference time period. A remote control device and a pointing device may be provided as the remote controller 200. The communication module 180 and the remote controller 200 transmit and receive data between each other using a ZigBee communication protocol.

If it is determined that a channel condition is inappropriate for communication, the communication module 180 compares channel energy of a current channel with those of other channels, sets a new channel, and stores channel information regarding the newly set channel in the storage 160. The channel energy represents a channel capacity which is the tightest upper bound on the amount of information that can be reliably transmitted over a communication channel.

The communication module 180 transmits to the remote controller 200 a channel switch request message. The channel switch request message includes a channel number as the channel information regarding the new channel.

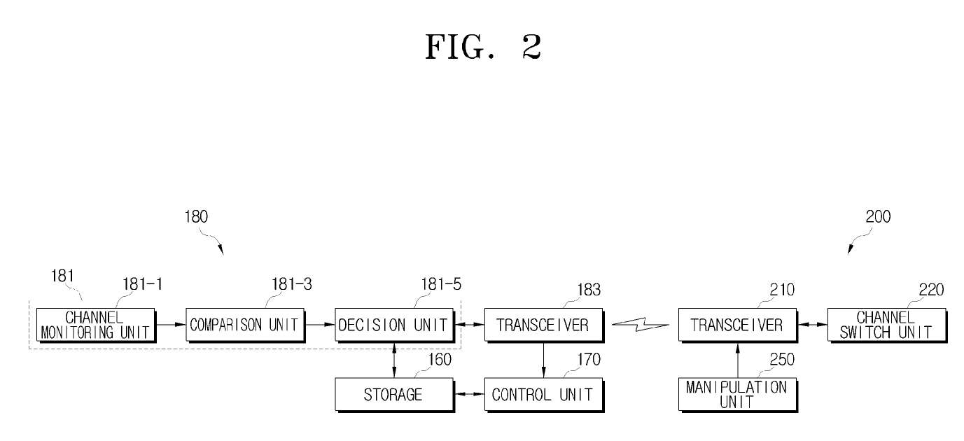

Hereinbelow, a method for switching a channel in a communication module of a broadcast receiving apparatus will be explained in detail with reference to FIG. 2.

FIG. 2 is a block diagram illustrating the structure of a communication module according to an exemplary embodiment of the present invention.

Referring to FIG. 2, the communication module 180 may comprise a channel switch unit 181 and a transceiver 183.

The channel switch unit 181 may comprise a channel monitoring unit 181-1, a comparison unit 181-3, and a decision unit 181-5, and may monitor a channel condition which is used to communicate with the remote controller 200 by a predetermined reference time period. If a current channel condition is inappropriate to communicate with the remote controller 200, the channel switch unit 181 compares channel energy of a current channel with those of other channels, and sets a new channel.

The channel monitoring unit 181-1 monitors the condition of a current channel, which is used to transmit and receive data to and from the remote controller 200, in a manner of scanning channels by a predetermined reference time period. If channel energy of a current channel is less than predetermined reference energy, the channel monitoring unit 181-1 determines that a current channel condition has deteriorated. That is, the channel estimation unit 181-1 determines that the current channel condition is inappropriate for data to be transmitted and received to and from the remote controller 200.

If the channel monitoring unit 181-1 determines that the current channel condition has deteriorated, the comparison unit 181-3 compares the channel energy of the current channel with that of one of a plurality of channels available for transmitting and receiving data to and from the remote controller 200.

Specifically, the comparison unit 181-3 compares channel energy of a selected channel with the sum of the current channel energy and predetermined reference energy. The comparison unit 181-3 selects one of the plurality of channels excluding the current channel. A channel may be selected according to an ascending sequence of channel numbers, but other arrangements are within the scope of this invention. For example, a channel having the greatest channel energy or a predetermined channel may be selected to have priority.

The comparison unit 181-3 compares channel energy until it determines that the sum of the current channel energy and the predetermined reference energy is less than the channel energy of a selected channel. That is, if it is determined that the sum of the current channel energy and a predetermined reference energy is equal to or more than the channel energy of a selected channel, the comparison unit 181-3 selects one of a plurality of channels excluding the current channel and the selected channel, and compares the channel energy of a newly selected channel with that of the current channel.

If it is determined according to the result of the comparison unit 181-3 that the sum of the current channel energy and the predetermined reference energy is less than the channel energy of the selected channel, the decision unit 181-5 stores channel information regarding the selected channel in the storage 160 under the control of the control unit 180, and sets the selected channel to be a new channel. If a message allowing channel switch is received through the transceiver 183, the decision unit 181-5 sets the new channel to be a current channel.

The transceiver 183 transmits to the remote controller 200 a channel switch request message, requesting a channel be switched to a newly set channel. The channel switch request message includes channel information regarding the selected channel. The transceiver 183 transmits the channel information to the remote controller 200 using a ZigBee communication protocol.

The transceiver 183 transmits a channel switch request message to the remote controller 200 when the remote controller 200 wakes up from a sleep mode. That is, if data are received from the remote controller 200, the transceiver 183 recognizes that the remote controller 200 wakes up from a sleep mode. The transmission and reception unit 183 transmits to the remote controller 200 an acknowledgement (ACK) to acknowledge receipt of a packet for the received data and the channel switch request message. The sleep mode represents that a user does not manipulate the manipulation unit 250 for a predetermined time period, during which power is supplied to essential components such as a central processing unit (CPU) of the remote controller 200.

A transceiver 210 of the remote controller 200 transmits a user command and data input through the manipulation unit 250 to the broadcast receiving apparatus 100, and receives channel information and a channel switch request message from the broadcast receiving apparatus 100. The transceiver 210 transmits test data to a switched channel, and if an ACK for test data is received, the transceiver 210 transmits data over switched channel.

If a predetermined time is elapsed, a channel switch unit 220 switches a current channel to a new channel with reference to the channel information included in the channel switch request message.

The channel switch unit 220 compares a current channel which is set to the broadcast receiving apparatus 100 with the channel information which is received from the broadcast receiving apparatus 100 to switch a channel.

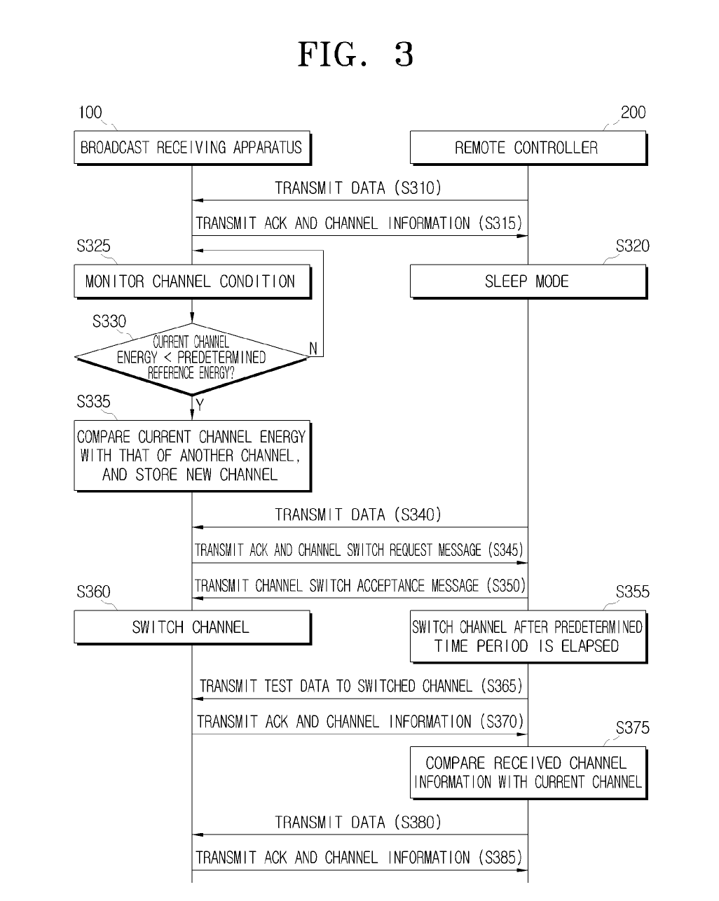

FIG. 3 is a flowchart provided to explain the operation of a broadcast receiving apparatus according to an exemplary embodiment of the present invention.

Referring to FIG. 3, the transceiver 210 of the remote controller 200 transmits data to the broadcast receiving apparatus 100 over a set current channel (S310). The operation of setting a current channel to communicate data between the broadcast receiving apparatus 100 and the remote controller 200 is a channel setting algorithm apparent to those skilled in the art, and thus detailed descriptions will be omitted.

The transceiver 183 of the broadcast receiving apparatus 100 transmits to the remote controller 200 an ACK packet for the data received from the remote controller 200 and the channel information regarding the current channel (S315), in which the channel information represents a channel number, and the broadcast receiving apparatus 100 and the remote controller 200 transmit and receive data with each other using a ZigBee communication protocol. For example, if a current channel is set to channel number CH1, the transceiver 183 transmits to the remote controller 200 the ACK packet for the data received in operation S310 and the channel information including the channel number CH1.

If a user does not input a manipulation command, the remote controller 200 enters the sleep mode (S320).

The channel monitoring unit 181-1 of the broadcast receiving apparatus 100 monitors a channel condition by a predetermined reference time period (S325).

Specifically, the channel estimation unit 181-1 compares the channel energy of the current channel CH1 with a predetermined reference energy, and if the channel energy of the current channel CH1 is less than the predetermined reference energy, the channel monitoring unit 181-1 performs the operation for switching the current channel CH1 to a new channel. If the channel energy of the current channel CH1 is equal to or more than the predetermined reference energy (S330:N), the channel monitoring unit 181-1 continues monitoring the current channel condition by the predetermined reference time period.

If the channel energy of the current channel is less than the predetermined reference energy (S330:Y), the comparison unit 181-3 compares the channel energy of the current channel with that of another channel, and the decision unit 181-5 sets a new channel with reference to the compared result, and stores the newly set channel (S335).

More specifically, if the channel energy of the current channel is less than the predetermined reference energy (S330:Y), the comparison unit 181-3 compares the sum of the channel energy of the current channel CH1 and the predetermined reference energy with the channel energy of a selected channel CH2 from a plurality of channels. A channel is selected from the plurality of channels excluding the current channel which are available for transmitting and receiving data between the broadcast receiving apparatus 100 and the remote controller 200 according to the predetermined priority order or ascending sequence of the channel number.

If the sum of the channel energy of the current channel CH1 and the predetermined reference energy is less than the channel energy of the selected channel CH2, the determination unit 181-5 stores a channel number which is channel information regarding the selected channel CH1, and sets the selected channel CH2 as a new channel to be switched.

If the remote controller 200 transmits data (S340), the broadcast receiving apparatus 100 recognizes that the remote controller 200 wakes up from the sleep mode. The transceiver 183 transmits to the remote controller 200 an ACK packet for the data received in operation S340 and a channel switch request message including the channel information regarding the newly set channel CH2 (S345).

If the channel switch request message is received, the transceiver 210 of the remote controller 200 transmits to the broadcast receiving apparatus 100 a message to indicate that the channel switch request is accepted (S350).

If a predetermined time period has elapsed since the reception of the channel switch request acceptance message, the channel switch unit 220 of the remote controller 200 switches the current channel to a new channel (S355). That is, the channel switch unit 220 switches the current channel CH1 to a new channel CH2 included in the channel switch request message.

If the channel switch request acceptance message is received, the determination unit 181-5 of the broadcast receiving apparatus 100 switches the current channel to the new channel (S360). That is, the determination unit 181-5 switches the current channel from channel number CH1 to channel number CH2 which is stored in operation S335.

The transceiver 183 of the broadcast receiving apparatus 100 receives test data from the remote controller 200 over the newly set channel (S365). That is, the transceiver 183 transmits the test data to the channel number CH2.

The transceiver 183 transmits an ACK packet for the received data and the channel information regarding a new current channel CH2 (S370). That is, the transceiver 183 transmits to the remote controller 200 the channel information including the channel number CH2 receiving the test data and an ACK packet for the test data.

The channel switch unit 220 of the remote controller 200 compares the received channel information with the current channel CH2 (S375), and transmits data according to the comparison result (S380).

Specifically, the channel switch unit 220 determines whether or not the channel number included in the channel information received in operation S370 corresponds to the channel number switched in operation S355. If the channel numbers correspond to each other, the transceiver 210 transmits data over the channel CH2 switched in operation S355 (S380). If the channel numbers do not correspond to each other, the channel switch unit 220 switches the current channel to the channel included in the channel information received in operation S370, or to the previous channel.

More specifically, if the channel information received in operation S370 includes a channel number CH3, the channel switch unit 220 compares the channel number CH2 to the channel number CH3 received in operation S370, and switches the current channel CH2 to the channel number CH3 received in operation S370 or to the previous channel number CH1.

The transceiver 183 of the broadcast receiving apparatus 100 transmits an ACK packet for the data received from the remote controller 200 and channel information of the current channel (S385). That is, the transceiver 183 transmits to the remote controller an ACK packet for the data received in operation S380 and channel information of the current channel.

If the channel information received from the broadcast receiving apparatus 100 in operation S375 corresponds to the current channel CH2 set to the remote controller 200, the transceiver 183 may transmit the channel number CH2 as the channel information of the current channel. On the other hand, if the channel information, that is, the channel number CH3 received from the broadcast receiving apparatus 100 in operation S375 does not correspond to the current channel CH2 set to the remote controller 200, the transceiver 183 may transmit the channel number CH3 as the channel information of the current channel, or the channel number CH1 which is previously set.

According to a method for switching a channel of the present invention, test data are transmitted and received in operations S365 and S370 to determine a channel condition of a switched channel. Accordingly, the operations may be omitted to directly switch a channel.

According to a broadcast receiving apparatus and a method for switching a channel of the present invention, operations S325 to 330 may be performed prior to operation S320. That is, the broadcast receiving apparatus 100 may monitor a channel condition of a current channel by a predetermined reference time period when the remote controller 200 is not in a sleep mode.

According to a broadcast receiving apparatus and a method for switching a channel of the present invention, messages for requesting and accepting channel switch may be transmitted and received between the broadcast receiving apparatus 100 and the remote controller 200 in a packet format.

The DTV 100 is provided as a broadcast receiving apparatus in the exemplary embodiment of the present invention, but it is merely an exemplary embodiment of the present invention. Alternatively, a broadcast receiving apparatus and a video apparatus other than the DTV may be applied to the present invention. That is, a broadcast receiving apparatus may be implemented as a settop box (STB), a digital multimedia broadcast (DMB) a receiving apparatus, a home theater, a television (TV), and various portable apparatuses having a broadcast receiving function such as a mobile phone, a navigation unit, and a personal multimedia player (PMP), and a video apparatus may be implemented as a digital video disc (DVD) player, a personal computer (PC), a digital camera, and a digital camcorder, for example.

As described above, according to the present invention, since a broadcast receiving apparatus requests to switch a channel, a channel used to communicate with a remote controller is easily switched irrespective of a sleep mode of the remote controller.

Furthermore, a channel condition of a broadcast receiving apparatus may periodically be monitored.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A broadcast receiving apparatus, comprising:
a channel switch unit which monitors a condition of a channel used to communicate with a remote controller, and sets a new channel according to energy of a monitored channel; and
a transceiver which transmits a channel switch request message to request a channel be switched to the new channel set by the channel switch unit.

2. The apparatus of claim 1, wherein if the energy of a current channel used to communicate with the remote controller is less than a predetermined reference energy, the channel switch unit compares the energy of the current channel with the energy of one of a plurality of channels, and sets the new channel based on the comparing.

3. The apparatus of claim 2, wherein the channel switch unit selects a channel to be compared with the current channel from the plurality of channels according to a predetermined channel priority order, and sets the selected channel to be the new channel if the energy of the selected channel is larger than the sum of the current channel energy and the predetermined reference energy.

4. The apparatus of claim 1, wherein if data are received from the remote controller, the transceiver transmits an acknowledgement packet for the received data and the channel switch request message to the remote controller.

5. The apparatus of claim 1, wherein if data are received from the remote controller, the transceiver determines that the remote controller wakes up from a sleep mode, and transmits the channel switch request message.

6. The apparatus of claim 1, wherein the transceiver receives a channel switch allowance message as a receipt for the channel switch request message, and the channel switch unit switches a channel to the new channel if the channel switch allowance message is received through the transceiver.

7. The apparatus of claim 1, wherein the transceiver receives data from the remote controller over the new channel, and transmits an acknowledge packet for the received data and channel information regarding a channel used to communicate with the remote controller to the remote controller over the new channel.

8. The apparatus of claim 1, further comprising:
a storage which stores channel information including a channel number of the new channel,
wherein the channel switch request message includes the channel information of the new channel.

9. The apparatus of claim 1, wherein the transceiver transmits the channel switch request message to the remote controller using a ZigBee communication protocol.

10. A method for switching a channel, comprising:
monitoring a condition of a channel used to communicate with a remote controller by a predetermined reference time, and setting a new channel according to energy of a monitored channel; and
transmitting a channel switch request message to request a channel be switched to the set new channel.

11. The method of claim 10, wherein the setting comprises:
if the energy of a current channel used to communicate with the remote controller is less than a predetermined reference energy, comparing the energy of the current channel with the energy of one of a plurality of channels, and setting the new channel based on the comparing.

12. The method of claim 11, wherein the setting comprises:
selecting a channel to be compared with the current channel from the plurality of channels according to a predetermined channel priority order; and
setting the selected channel to be the new channel if the energy of the selected channel is larger than the sum of the current channel energy and the predetermined reference energy.

13. The method of claim 10, wherein the transmitting comprises:
if data are received from the remote controller, transmitting an acknowledgement packet for the received data and the channel switch request message to the remote controller.

14. The method of claim 10, wherein the transmitting receives a channel switch allowance message as a receipt for the channel switch request message, and the setting switches a channel to the new channel if the channel switch allowance message is received.

15. The method of claim 10, wherein the transmitting comprises:
receiving data from the remote controller over the new channel, and transmitting an acknowledge packet for the received data and channel information regarding a channel in which the acknowledge is transmitted over the new channel.

16. The method of claim 10, further comprising:
storing channel information including a channel number of the new channel,
wherein the channel switch request message includes the channel information of the new channel.

17. The method of claim 10, wherein the transmitting transmits the channel switch request message using a ZigBee communication protocol.

18. A remote controller, comprising:
a transceiver which receives a channel switch request message from an external apparatus, and transmits a channel switch allowance message as a receipt for the channel switch request message; and
a channel switch unit which switches a current channel used to communicate to the external apparatus according to the channel switch request message received through the transceiver.

19. The remote controller of claim 18, wherein the channel switch request message includes channel information representing a channel number of a channel to be switched, and the channel switch unit switches the current channel to the channel number included in the channel switch request message if a predetermined time is elapsed since the channel switch allowance message is transmitted through the transceiver.

20. The remote controller of claim 18, wherein the transceiver transmits and receives data over the channel switched by the channel switch unit.

21. A method for switching a channel, comprising:
receiving a channel switch request message from an external apparatus, and transmitting a channel switch allowance message as a receipt for the channel switch request message; and
switching the current channel used to communicate with the external apparatus according to the received channel switch request message.

22. The method of claim 21, wherein the channel switch request message includes channel information representing a channel number of a channel to be switched, and the switching switches the current channel to the channel number included in the channel switch request message if a predetermined time is elapsed since the channel switch allowance message is transmitted at the transmitting.
